(19) United States
(12) Patent Application Publication
(10) Pub. No.: US 2025/0283474 A1
(43) Pub. Date: Sep. 11, 2025

(54) LOW CARBON EMISSION COMPRESSION STATION WITH DUAL USE CAPABILITY

(71) Applicant: Nuovo Pignone Tecnologie - S.r.l., Florence (IT)

(72) Inventors: Andrea INTIERI, Florence, Firenze (IT); Marco BALDINI, Florence, Firenze (IT); Marco SANTINI, Florence, Firenze (IT)

(21) Appl. No.: 18/859,811

(22) PCT Filed: Apr. 26, 2023
(86) PCT No.: PCT/EP2023/025192

§ 371 Date: Oct. 24, 2024

(30) Foreign Application Priority Data
Apr. 29, 2022 (IT) 102022000008660

(51) Int. Cl. F04D 25/06; F02C 6/06; F04D 27/02; F17D 1/07; F17D 3/01

(52) U.S. Cl. CPC F04D 25/06; F02C 6/06; F04D 27/02; F17D 1/07; F17D 3/01

(57) ABSTRACT

A low carbon emission compression station is disclosed. The compression sta¬tion is connected to a gas handling system and to an electric grid and comprises at least one electric motor driven compressor. Additionally, the compression station is con¬nected to auxiliary energy sources and energy storage devices, comprises a supervision system, and is configured to operate in dual mode, i.e. is configured to: use power from the electric grid to compress the gas in the gas handling system and/or store energy in excess into said energy storage devices; and/or exploit auxiliary energy sources and/or stored energy to compress the gas in the gas handling system and/or also to deliver energy in excess to the electric grid.

### TECHNICAL FIELD

The present disclosure concerns improvements to compressor stations, typically used in gas pipeline and storage, capable of increasing the overall system efficiency by reducing carbon emissions. In particular, but not exclusively, the disclosure concerns a compression station provided with an electric motor driven compressor together with auxiliary renewable and energy storage systems in such an arrangement and sizing capable of achieving an extremely optimized integration between an electric grid and the gas infrastructure.

### BACKGROUND ART

It is well known that natural gas is extracted from deep underground rock formations and need to be transported to the end users. When it is possible, or economically feasible, pipeline and underground gas storage systems are generally used for transporting and storing natural gas. To offset pressure losses during transportation, the pipelines require compressor stations, which are typically arranged along the pipe-line at regular intervals. These compressors must work with high reliably and availability. In particular, since the pipelines extend over long distances and compression stations can be positioned in remote locations, lacking an electric grid or, even if an electric grid is available, wherein such an electric grid is not reliable, a compression station generally comprises a dedicated power generation island, to provide power for auxiliary systems, allowing the compression station to operate separate from the electrical grid, or to operate also when the electric grid is not operative. It is also known that, in order to allow these compressors to work reliably, the compressor station often comprises auxiliary energy sources and/or auxiliary energy storage systems. For example, seasonal variability of gas demand can result in surplus gas that is withdrawn from the pipeline and compressed, stored and then taken from gas storage facilities at times of peak demand. By combining such compressors with gas turbines, the already stored gas can be used as the gas turbines' fuel to drive compressor and guarantee the necessary operability of the compressor.

It is also known from the prior art that compressor stations for pipeline applications, as well as other rotating equipment for applications in the oil and gas industry, can be conveniently driven by an electric motor connected to the electrical grid. The use of a variable-frequency drive (VFD) enables speed variation with top efficiencies over the entire operating range, which reduces power consumption.

Accordingly, an improved compression station capable of achieving a high degree of integration between the gas pipeline and the electric network would increase the reliability of the compression station and would be welcome in the field. Additionally, an improved compression station of this kind would allow decarbonization, by decreasing emissions and reducing electric power consumption. More specifically, it would be welcome a compression station, comprising auxiliary energy sources and/or auxiliary energy store systems conceived to operate in a dual mode, alternatively utilizing power from the electric grid to compress the gas in the pipeline and store energy in excess into energy store systems or exploiting renewable sources and stored energy to compress the gas in the pipeline and also to deliver energy in excess to the electric grid, with an increased flexibility and reliability.

### SUMMARY

In one aspect, the subject matter disclosed herein is directed to a low emission compression station, comprising an electric motor driven compressor together with auxiliary energy sources and energy storage systems, including a possible integration with a battery pack, wherein the integration between the different sources and loads is controlled/supervised by a supervision system, depending on variables including gas and/or energy cost, available storage capacity, auxiliary energy sources capability.

In another aspect, the subject matter disclosed herein concerns a low emission compression station wherein the compression station is complemented with auxiliary energy sources, such as renewable sources (e.g. solar panels or wind turbines), fuel cells, electrolyzers, and energy storage devices, such as batteries and gas storage, to allow the low emission compression station to operate in a dual mode when integrated with an external electric grid, alternatively consuming power from the electric grid or delivering power to the electric grid, according to variable overall conditions, such as seasonal variability of gas demand.

In still another aspect, the subject matter disclosed herein concerns a low emission compression station wherein a supervision system is configured to manage all the energy sources (battery, emergency, renewable sources) in order to align each other thereof.

In yet another aspect, the subject matter disclosed herein concerns a low emission compression station wherein the supervision system is configured to manage the loads shedding.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a scheme of a low emission compression station according to a first embodiment of the present disclosure;

FIG. 2 illustrates a scheme of a low emission compression station according to a second embodiment of the present disclosure;

FIG. 3 illustrates a scheme of a low emission compression station according to a third embodiment of the present disclosure; and

FIG. 4 illustrates a scheme of a low emission compression station according to a fourth embodiment of the present disclosure.

### DETAILED DESCRIPTION OF EMBODIMENTS

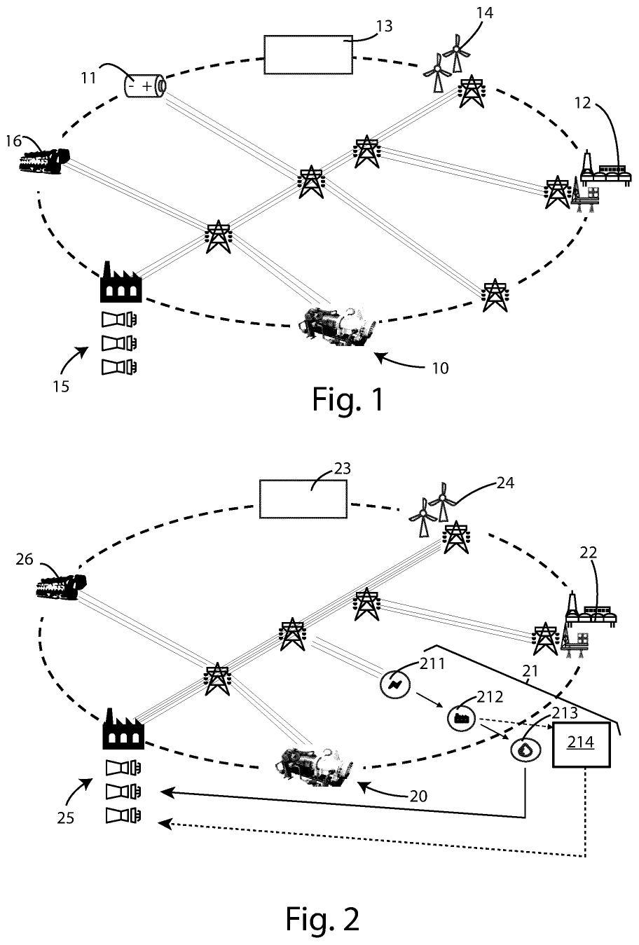

Making reference to FIG. 1, a low emission compression station according to a first embodiment of the present disclosure comprises an electric motor driven compressor (referred to with numeral 10) together with an energy storage system 11, including for example one or more of a battery pack, a battery energy storage system (BESS), liquid air energy storage (LAES), compressed air energy storage (CAES), hydrogen storage or similar, and oil and gas compression station facility auxiliary systems 12, which are sized and controlled/supervised by a supervision system 13 in order to guarantee a full uninterrupted power supply to the compressor station, by managing the availability of electric energy produced/stored by the other components of the compression station. FIG. 1 also shows one or more renewable power system 14, a power generation island 15 and an emergency power generation island 16, which is optional according to the present disclosure. The renewable power system 14, power generation island 15 and emergency power generation island 16 are also controlled/supervised by the supervision system 13.

In particular, during or along the day and night the renewable energy system 14 can supply renewable power to the electric compressor 10, any excess power being stored in the energy storage system 11. The power generation island 15 can comprise one or more gas turbines, to generate power by combustion of natural gas or renewable gas, such power being used to operate the electric compressor 10 overnight.

In particular, the solution according to the present disclosure leverages renewable power to decarbonize the compression, i.e. to compress the gas of a gas handling system by reducing CO₂ at the same time. Moreover, by the solution according to the present disclosure a gas handling system can comprise compression, transport, injection and storage apparatuses.

FIG. 2 shows a low emission compression station according to a second embodiment of the present disclosure. The system configuration comprises an electric motor driven compressor 20 and relevant electrical machines, including oil and gas compression station facility auxiliary systems 22, one or more renewable power system 24, a power generation island 25 and an emergency power generation island 26, which is optional according to the present disclosure. The above mentioned components are controlled/supervised by a supervision system 23 in order to guarantee a full uninterrupted power supply to the compressor station. In this embodiment, an energy storage system is configured as a hydrogen storage system 21, the hydrogen storage system being composed of an electrolyzer 211 to produce hydrogen, together with a compressor 212 and a storage tank 213 and a connection to a gas handling system 214, where hydrogen can be optionally blended with natural gas. Hydrogen from the hydrogen storage tank 213 is fed to the turbines of the power generation island 25, optionally in a blend including natural gas. Hydrogen sent to the gas handling system through the connection 214, optionally blended with natural gas, can also be used to operate the turbines of the power generation island 25. The combustion of the blend composed of hydrogen together with natural gas also contributes to reduce the production of CO₂.

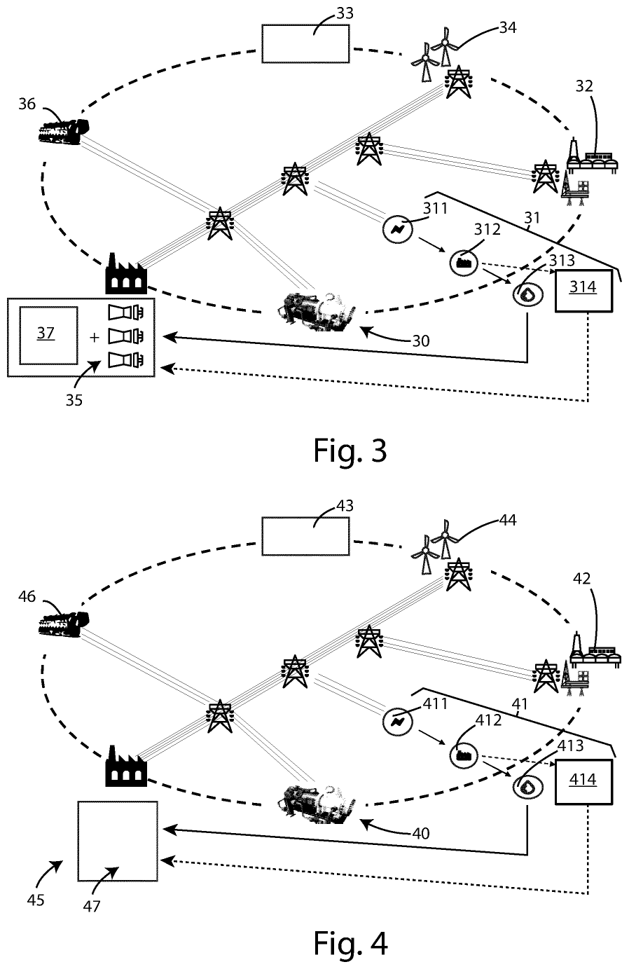

FIG. 3 shows a low emission compression station according to a third embodiment of the present disclosure. The system configuration comprises the electric motor driven compressor 30 and the relevant electrical machines, including a hydrogen storage system 31, oil and gas compression station facility auxiliary systems 32, one or more renewable energy system 34, a power generation island 35 and an emergency power generation island 36, which are controlled/supervised by an electrical supervision system 33 in order to guarantee a full uninterrupted power supply to the compressor station. The power generation island 35 includes a fuel cell 37 (such as a solid oxide fuel cell). The hydrogen storage system 31 is composed of an electrolyzer 311, a compressor 312 and a storage tank 313 and a connection to a gas handling system 314, where hydrogen can be optionally blended with natural gas. The turbines of the power generation island 35 and the fuel cell 37 are fed with hydrogen from the hydrogen storage tank 313 and/or with hydrogen or natural gas or a mixture of hydrogen and natural gas from the gas handling system 314.

FIG. 4 shows a low emission compression station according to a fourth embodiment of the present disclosure. The system configuration comprises the electric motor driven compressor 40, and the relevant electrical machines, including a hydrogen storage system 41, oil and gas compression station facility auxiliary systems 42, one or more renewable energy system 44, a power generation island 45 and an emergency power generation island 46, which are controlled/supervised by a supervision system 43 in order to guarantee a full uninterrupted power supply to the compressor station. The power generation island 35 is composed of a fuel cell 47 (such as a solid oxide fuel cell). The hydrogen storage system 41 is composed of an electrolyzer 411, a compressor 412 and a storage tank 413, and a connection to a pipeline 414. The fuel cell 47 is fed with hydrogen from the hydrogen storage tank 413 and/or with hydrogen or natural gas or a mixture of hydrogen and natural gas from the gas handling system 414.

While the invention has been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

Reference has been made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When elements of various embodiments are introduced, the articles “a”, “an”, “the”, and “said” are intended to mean that there are one or more of the elements. The terms “comprising”, “including”, and “having” are intended to be inclusive and mean that there may be additional elements other than the listed elements.

1. A low carbon emission gas compression station connected to a gas handling system and to an electric grid, wherein the gas compression station:
comprises at least one electric motor driven compressor;
is also connected to auxiliary energy sources and energy storage devices;
comprises a supervision system, and is configured to operate in dual mode, the dual mode configured to operate by one or more of:
using power from the electric grid to compress the gas in the gas handling system and/or store energy into said energy storage devices; or,
exploiting auxiliary energy sources and/or stored energy to compress the gas in the gas handling system and/or to deliver energy to the electric grid.

2. The low carbon emission compression station according to claim 1, wherein the supervision system is configured to balance different sources and loads, depending on available storage capacity and auxiliary energy sources capability.

3. The low emission compression station according to claim 2, wherein the supervision system is configured to balance different sources and loads, depending also on gas and/or energy cost.

4. The low emission compression station according to claim 1, wherein said gas handling system comprises compression, transport, injection and storage apparatuses.

5. The low emission compression station according to claim 1, wherein said auxiliary energy sources comprise one or more of power generation islands, renewable sources, fuel cells and energy storage.

6. The low emission compression station according to claim 5, wherein said power generation islands comprise one or more gas turbines.

7. The low emission compression station according to claim 5, wherein said renewable sources comprise solar panels or wind turbines.

8. The low emission compression station according to claim 1, wherein said energy storage devices comprise a battery pack (or BESS), H₂ storage systems, liquid air energy storage devices (LAES) and compressed air energy storage devices (CAES).

9. The low emission compression station according to claim 1, wherein an emergency power generation system is present.

10. The low emission compression station according to claim 2, wherein an emergency power generation system is present.

11. The low emission compression station according to claim 3, wherein an emergency power generation system is present.

12. The low emission compression station according to claim 4, wherein an emergency power generation system is present.

13. The low emission compression station according to claim 5, wherein an emergency power generation system is present.

14. The low emission compression station according to claim 6, wherein an emergency power generation system is present.

15. The low emission compression station according to claim 7, wherein an emergency power generation system is present.

16. The low emission compression station according to claim 8, wherein an emergency power generation system is present.
